(19) United States
(12) Patent Application Publication
(10) Pub. No.: US 2004/0183234 A1
(43) Pub. Date: Sep. 23, 2004

(54) Method of forming a three-dimensional sculpture

(76) Inventor: Ovidiu Colea, Glen Cove, NY (US)

Correspondence Address: KATTEN MUCHIN ZAVIS ROSENMAN, 575 MADISON AVENUE, NEW YORK, NY, 10022-2585, US

(21) Appl. No.: 10/392,703

(22) Filed: Mar. 20, 2003

(51) Int. Cl. H05B 6/00; B29C 33/40; B29C 41/22

(52) U.S. Cl. 264/446; 264/255; 264/74; 264/227

(57) ABSTRACT

A method of forming a three-dimensional sculpture comprises the steps of providing a mold having a lining and a casting cavity, applying a powder to the mold lining, pouring a casting material into the casting cavity and curing the casting material to form a casting object, said powder being transferred to said casting object during curing of said casting material, and removing said casting object from said casting cavity to form a powder-laden three-dimensional sculpture.

### FIELD OF THE INVENTION

The present invention relates generally to a method of forming a three-dimensional sculpture, and more particularly to a method of applying a fine powder to a mold surface and then casting an object from such mold to form a three-dimensional sculpture having an aesthetic appearance dictated by the adherence of the fine powder to the mold casting.

### BACKGROUND OF THE INVENTION

Prior art methods of forming three-dimensional sculptures with acrylic and clear plastic castings are known to involve the spray-painting of a liquid-base medium onto a clear or plastic three-dimensional object and then pouring a casting material over such painted object and into a mold to form a paint-coated three-dimensional casting sculpture. However, the use of paint with certain kinds of acrylic or clear plastic objects can be very limiting, particularly since such a liquid-based medium is washable when embedded and can produce separation in the process of casting.

Recognizing the limitations of the prior art, the present inventor has devised a method of creating a clear three-dimensional sculpture by using molds with linings that are particularly adapted to receive and retain a fine powder material. During casting, the fine powder material is transferred to the object defined by a casting cavity and this results in the transformation of the casted object into an aesthetic sculpture. The resultant casted object is clear with the exception of the transferred powder that covers its outer surface or surfaces and provides an aesthetic contour to the casted object.

### SUMMARY OF THE INVENTION

A method of forming a three-dimensional sculpture comprises the steps of providing a mold having a lining and a casting cavity, applying a powder to the mold lining, pouring a casting material into the casting cavity and curing the casting material to form a casting object, said powder being transferred to said casting object during curing of said casting material, and removing said casting object from said casting cavity to form a powder-laden three-dimensional sculpture.

### BRIEF DESCRIPTION OF THE DRAWINGS

FIG. 1 is a front view of a three-dimensional model used to illustrate one embodiment of the method of the present invention.

FIG. 2 is a rear view of the model of FIG. 1.

FIG. 3 is a side view of the model of FIG. 1.

FIG. 4 illustrates the creation of a mold using the model of FIGS. 1-3.

FIG. 5 is a top view of one mold half used in the method of the invention.

FIG. 6 is a top view of the other mold half used in the method of the invention.

FIG. 7 is a cross-sectional view of the mold half of FIG. 5.

FIG. 8 is a cross-sectional view of the mold half of FIG. 6.

FIG. 9 illustrates one method of applying powder to a mold surface.

FIG. 10 illustrates the casting of a material inside a mold formed from mold halves illustrated in FIGS. 5-8.

FIG. 11 illustrates a casting object formed in accordance with the method of the invention.

FIG. 12 illustrates the casting object of FIG. 111 embedded in another mold in accordance with a method of the invention.

FIG. 13 illustrates a sculpture formed in accordance with the method of the invention.

FIG. 14 illustrates an alternative embodiment of a casting object formed in accordance with the method of the invention.

FIG. 15 illustrates an alternative embodiment of a pair of molds situated in preparation for casting in accordance with the method of the invention.

FIG. 16 illustrates the joinder of the molds of FIG. 15.

FIGS. 17-18 illustrate a casting object formed by using the molds of FIGS. 15-16.

FIG. 19 is a top view of an alternative embodiment of a casting created in accordance with the method of the invention.

FIG. 20 is a side view of an alternative embodiment of a casting created in accordance with the method of the invention.

### DETAILED DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

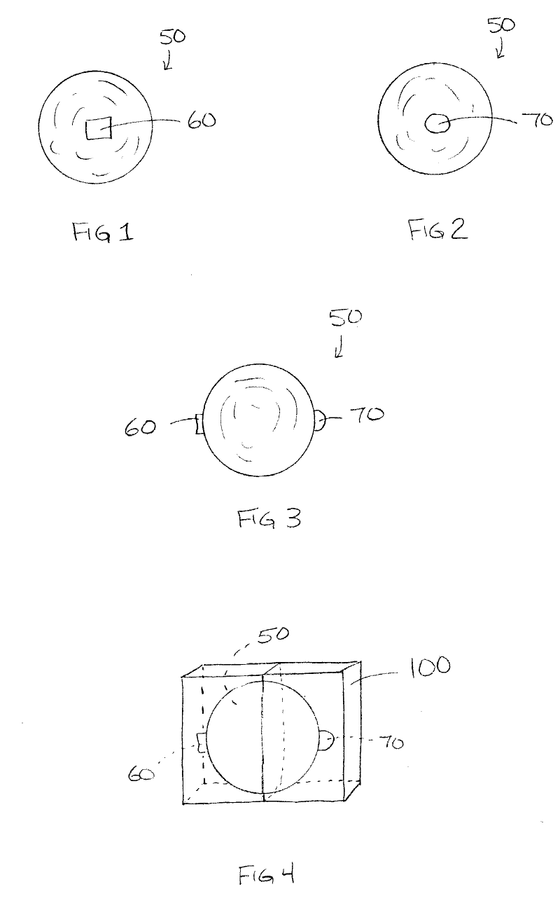

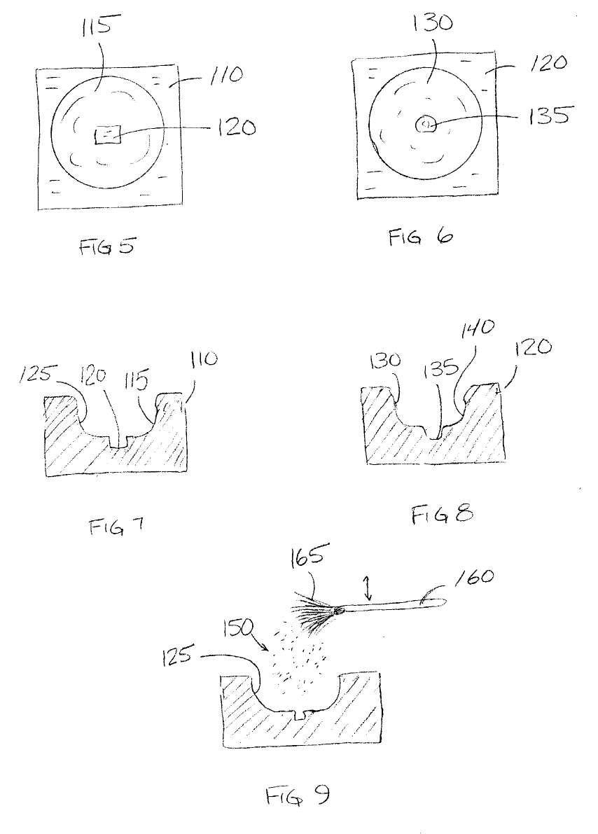

FIG. 1 is a front view, FIG. 2 is a rear view and FIG. 3 is a side view of a three-dimensional spherical model 50 used for purposes of illustrating one embodiment of the method of the present invention. A square protrusion 60 extends from the front of the model 50, while a round protrusion 70 extends from the rear of the model 50, both protrusions 60, 70 being visible from the side view of FIG. 3 and are present in this example to distinguish between the front and rear sides of the model 50. For purposes of explanation, the model 50 is formed from a solid, opaque material such as clay, metal or rubber, and is being illustrated as a very simple shape. More complicated shapes are clearly contemplated. As will be illustrated below, the desired outcome is a clear, three-dimensional sculpture with a powdered outer contour that is reflective of the outer surface contour of the three-dimensional model 50.

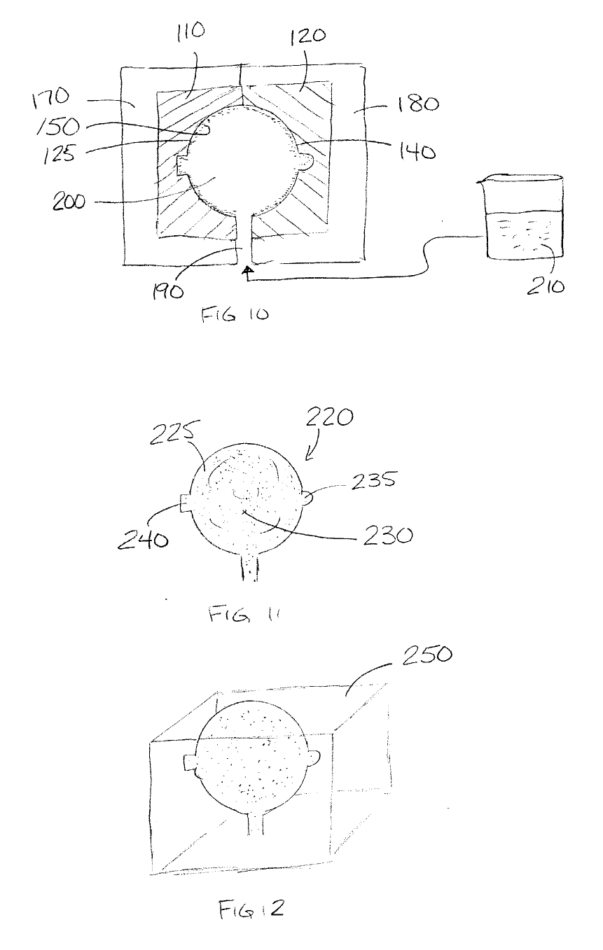

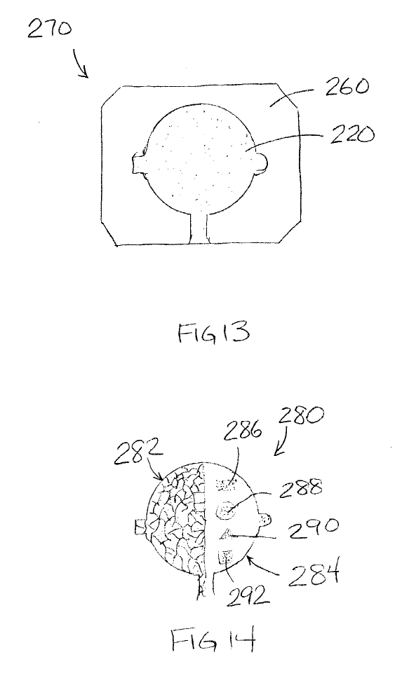

FIG. 4 illustrates the simplified creation of a silicone mold 100 of the three-dimensional model 50. The model 50 may be supported in a plaster mold with silicone material cast around the model, or other methods of creating the mold 100 may be used. The mold 100 is then separated into first and second halves 110, 120 illustrated in FIGS. 5-8. FIGS. 5 and 7 illustrate an impression 115 of the front side of the model 50 (FIG. 1) and an impression 120 of the square protrusion 60. FIGS. 6 and 8 illustrate an impression 130 of the rear side of the model 50 (FIG. 2) and an impression 135 of the square protrusion 70.

Such impressions 115, 120, 130, 135 form the mold surfaces 125 (FIG. 7), 140 (FIG. 8) on which powder 150 (FIG. 9) is applied. First, however, the mold surfaces 125, 140 are cleaned with a high-powered jet of air and brushed on with a very soft brush to create an electrostatic charge on the mold surfaces. Other methods of inducing an electrostatic charge are also contemplated. Such charge assists the application and retention of very fine powder 150, such as particles of translucent mica or any other fine powder, such as mineral powder, metal powder, dry colors and the like. Other types of particulate material are contemplated.

Once the mold surfaces 125, 140 are cleaned, powder 150 is applied preferably by using a brush 160 as shown in FIG. 9. The bristles 165 of the brush 160 may be applied directly (swiped) to one or both of the mold surfaces 125, 140, or the brush 160 may be vibrated (by hand or mechanically) above the mold surfaces 125, 140 to dust the powder onto the mold surfaces. Other methods of applying powder such as shaking the brush (raining) or controlled tapping of the brush above the mold surfaces, or a combination of tapping, brushing, dusting, dry spraying (with a dry spray gun for example) and raining may be used at various locations along the mold surfaces to create the desired end result.

The powder will be attracted to the mold surfaces 125, 140 and stick thereon by virtue of the electrostatic charge imparted thereto as discussed above. Powder may be applied to one or both of the mold surfaces 125, 140, and such application may be of uniform or varying intensity. For example, if applying powder to both mold surfaces 125, 140, it may be preferable to apply a higher intensity of powder or use a darker color powder on one mold surface relative to the other mold surface so that such higher-intensity surface will be more pronounced and visible when the three-dimensional sculpture is formed.

Once the powder has been applied to the mold surfaces, excess powder may be removed with low-pressure air and afterwards, the mold surfaces are brought together and enclosed (FIG. 10) in a casting mold having halves 170, 180. Because the mold surfaces are charged, a low pressure jet of air will not disturb the powder that has been applied to the mold surfaces. An opening 190 is provided through the mold halves 170, 180 and 110, 120 to provide access to a casting cavity 200 defined between the powder-laden mold surfaces 125, 140. A plastic material 210 such as clear polyester, acrylic, epoxy or the like is then introduced into the casting cavity 200 through the opening 190 and then allowed to cure until the casting material 210 hardens. Such curing may be expedited by varying the temperature and/or pressure of the mold environment. The material 210 is selected so that it cures transparent or translucent, even though the material 210 may not be clear when it initially enters the casting cavity 200 as is the case with some plastics.

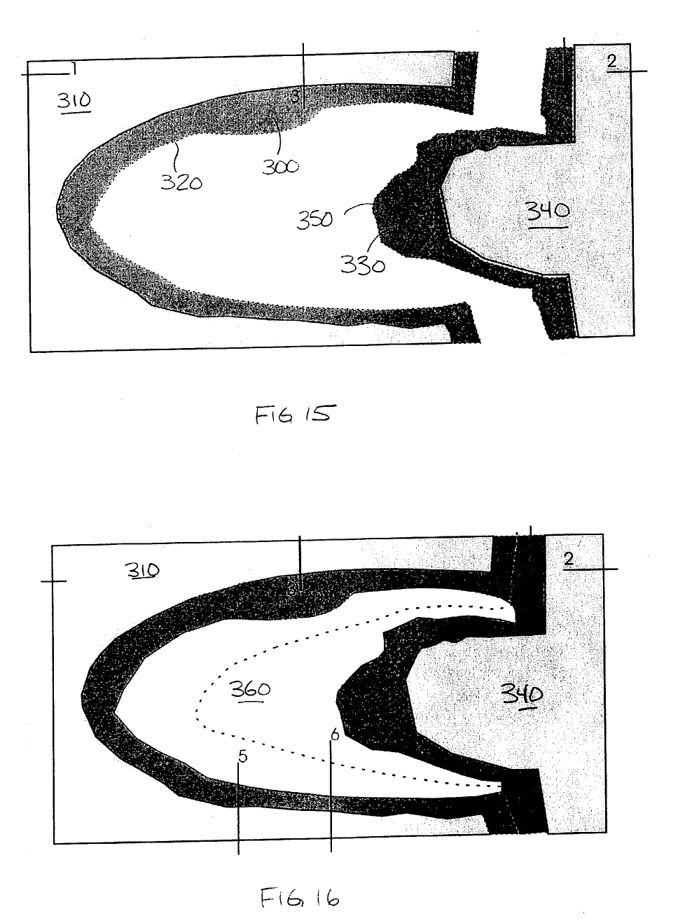

After the casting material 210 is cured, the casting object 220 (FIG. 11) is removed from the mold 110, 120 as shown in FIG. 11 to form a three-dimensional sculpture. The powder 150 that originally lined the mold surfaces 125, 140 (FIG. 10) has been transferred from the mold surfaces 125, 140 to the casting object 220, such that the outer surface 225 of the casting object 220 is covered with powder 150, while the interior 230 of the casting object 220, or the casting object as a whole, is clear (preferably transparent or translucent depending on the nature of the casting material 210). If the silicone mold surfaces are too dry during the electrostatic charging process described above, a release agent may be sprayed onto the mold surfaces to assist in the transfer of the powder to the casting object and the later separation of the casting object 220 from the mold surfaces 125, 140. If, however, the powder is too densely applied such that the powder is not evenly transferred to the casting object, any residual powder may be sandblasted or washed off the mold surfaces in preparation for the casting of another object.

Thus, for example, the powder-coated surface 235 (FIG. 11) around the round protrusion (see FIG. 2) may be visible through the interior 230 of the casting object 220 by looking through the powder-coated surface 240 around the square protrusion. This is particularly the case if, for example, a fine or light-colored layer of powder was applied to the mold surface 125 and a heavier or dark-colored layer of powder was applied to the mold surface 140. Similarly, if, for example, a red-colored powder was applied only to the mold surface 125 on the square impression (see FIGS. 5, 7), and a gold-colored powder was applied to the remaining mold surface 125, and a light-silver powder was applied to the entirety of the mold surface 140, the casting object 220 created therefrom would have an aesthetic quality whereby the square portion 240 is red and visible by looking through the round portion 235.

The powder-laden three-dimensional sculpture formed by the casting object 220 may be further aesthetically improved by suspending or otherwise supporting the casting object 220 within another mold 250 (FIG. 12) and then introducing the same casting material 210 (FIG. 10) around the casting object 220. Introducing the same casting material 210 around the casting object 220 does not disturb the powder that has already adhered thereto because such powder has become chemically bonded to the casting object and will not easily release therefrom. Once the same casting material 210 cures in accordance with the discussion above, such cured material 260 (FIG. 13) and the embedded casting object 220 are removed from the mold 250 to form a three-dimensional sculpture 270 (FIG. 13). Because the cured material 260 is formed from the same material that was used to form the casting object 220, and because the cured material 260 is clear upon hardening, the casting object 220 appears to float or be suspended within the cured material 260. The cured material 260 can be finished by cutting, polishing or the like to provide an aesthetically pleasing sculpture 270.

Various aesthetic modifications can be imparted during the creation process that can drastically change the resultant casting object. For example, FIG. 14 illustrates a casting object 280 having a different appearance on each half of the object. On the left side 282, the powder covering exhibits a cracking appearance, which is the result of an increased density of metal or mineral powder applied to its corresponding mold surface. If casting object 280 is formed from molds 110, 120 (FIGS. 5-10), then the cracking effect 282 would be created by applying a heavy layer of powder on mold surface 125. The cracking effect can be controlled by modifying the amount and type of powder applied to the mold surface. The cracking (aging) effect will happen only when the object is embedded into the clear material (see FIGS. 12-13) due to the 5-7% shrinkage of the material in the process of curing. To eliminate the shrinkage effect, the embedded piece should be in an uncured state. On the right side 284 of the casting object 280 there is provided a plurality of shaped sections 286, 288, 290, 292 that are generated by applying powder only to discrete portions of the mold surface 140, with the remainder of the mold surface being free of powder. By applying powder only to discrete portions of the mold surface, the resultant powder sections on the casting object appears to be floating in space. This is particularly evident if the casting object is then embedded in another casting as shown in FIGS. 12-13.

FIGS. 1-14 illustrate a simplified explanation of the method of the present invention. Such method can be applied to create various artistic works. For example, while FIGS. 1-14 illustrate the creation of a three-dimensional sculpture 270 from a single three-dimensional model 50, a three-dimensional artistic sculpture can be created by using a combination of two or more separate pre-existing objects or models.

For example, to produce a unique three-dimensional object or sculpture 400 (FIG. 18), two or more independent, pre-existing sculptures or objects can be used to create molds that are then combined to form the sculpture 400. FIG. 15 illustrates a first silicone mold 300 supported by a first support mold half 310 and having a mold surface 320 that is representative of an artistic feature from a first object or sculpture (not shown). A second silicone mold 330 supported by a second support mold half 340 has a mold surface 350 that is representative of an artistic feature from a second object or sculpture (not shown). The mold halves 310, 340 are then brought together (FIG. 16) and a casting material is introduced into the casting cavity 360.

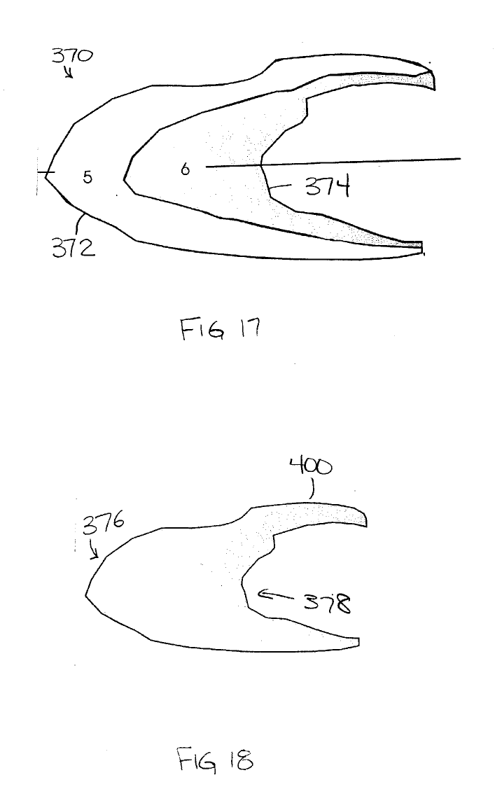

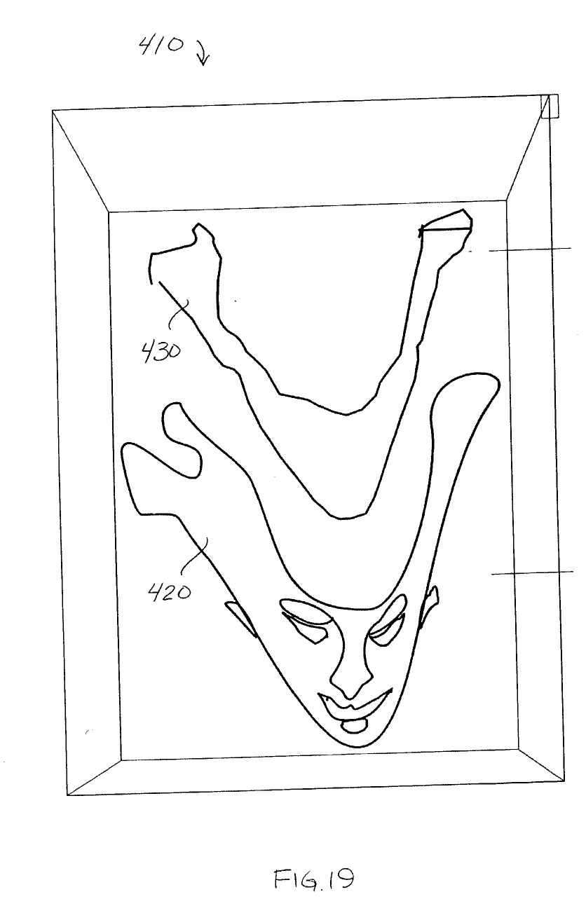

FIG. 17 illustrates the casting object 370 formed with first and second surface contours 372, 374 that are each representative of independent objects. Thus, if one object is a dog face and the other object is a cat face, the first surface contour 372 might represent the image of a dog, while the second surface contour might represent the image of a cat. Continuing with such example, the resultant sculpture 400 (FIG. 18) would then have the positive image of a dog on one side 376, and the negative image of a cat on the other side 378. Such sculpture 400 could then be used to create a powder-laden three-dimensional sculpture 270 as shown in FIG. 13 and in accordance with the method illustrated in connection with FIGS. 1-14, wherein a positive image of a dog would be viewable by looking at one side of the sculpture 270 and a negative image of a cat would be viewable by looking at the other side of the sculpture 270, and a spaced-apart positive image of a cat might be viewable by looking through the positive image of the dog depending on if the cat side is powdered differently than the dog side.

FIG. 19, which is a top view of a three-dimensional sculpture 410, illustrates how the process of FIGS. 15-18 can be used to create a three-dimensional sculpture 410 having a positive image 420 and a negative image 430 that are spaced apart from each other to give the impression of depth. If the positive and negative images 420, 430 are identical in design, which is created by forming mold halves 320, 330 (FIG. 15) from the same surface of the same model (not shown), the resultant sculpture 410 would appear to have an image that is echoed in space. Depending on how each image is powdered and/or colored in accordance with the method described above, each image may be viewable through the other image, creating a unique visual effect.

Identical positive and negative images may be formed by first creating a negative silicone mold of the image, and then using such negative silicone mold to create a negative casting mold, which negative casting mold will then be used to create a positive silicone mold of the same image. Once the positive and negative silicone molds are created, they are arranged on support molds as illustrated in FIGS. 15-16 to form a three-dimensional model (FIG. 18), from which a powder-laden, three-dimensional sculpture will be formed in accordance with the method described in connection with FIGS. 1-14. It will be appreciated that the creation of the three-dimensional model as seen in FIG. 18, from identical positive and negative images, requires a certain amount of artistic talent, since the “two-dimensional” images must be connected somehow to form the three-dimensional model.

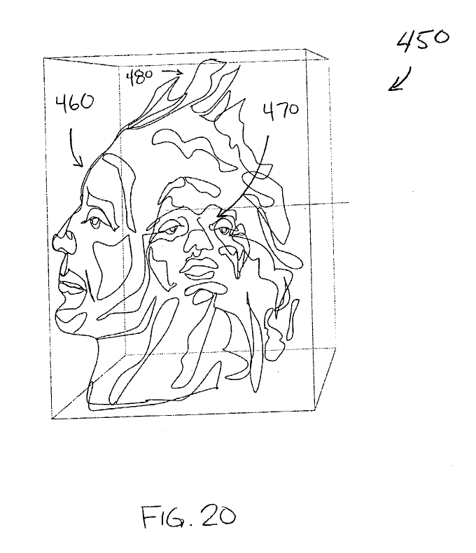

In other words, if the three-dimensional model is cast in plaster, and each image is representative of a face, an artist may connect the positive image of the face and the negative image of the face with a unique hair arrangement so that the faces appear to flow together. Following such example, FIG. 20 illustrates an artistic rendering of a side view of a three-dimensional sculpture 450 created in accordance with the method of the present invention. A positive image of a face 460 is spatially connected to the negative image of the same face 470 (shown positive through the first face 460) by an artistic hair treatment 480, such hair treatment 480 being created during the model-creation phase illustrated in FIGS. 15-18. If the sculpture 450 were rotated around, such that the viewer were looking directly into the negative image of the face 470, both faces 460 and 470 would appear to be somewhat negative. If instead a three-dimensional model was creating using two identical positive images of faces, the resultant three-dimensional sculpture would appear to have two faces extending in opposite directions from the same head. If instead a three-dimensional model was creating using three or four identical positive images of faces, the resultant three-dimensional sculpture would appear to have multiple faces extending in various directions from the same head. Thus, the artistic possibilities are endless.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

I claim:

1. A method of forming a three-dimensional sculpture comprising the steps of:
a) providing a first mold having a first mold surface and a second mold having a second mold surface,
b) applying a powder to at least one of said first and second mold surfaces,
c) joining said first and second molds to form a casting cavity between said first and second mold surfaces,
d) pouring a casting material into said casting cavity and curing said casting material to form a casting object, said powder being transferred to said casting object during curing of said casting material, and
e) removing said casting object from said casting cavity to form a powder-laden three-dimensional sculpture.

2. A method in accordance with claim 1, wherein said powder is brushed onto at least one of said first and second mold surfaces.

3. A method in accordance with claim 1, wherein said powder is sprayed onto at least one of said first and second mold surfaces.

4. A method in accordance with claim 1, wherein said powder is dusted onto at least one of said first and second mold surfaces by tapping a brush on which said powder is contained.

5. A method in accordance with claim 1, wherein said powder is rained onto at least one of said first and second mold surfaces by shaking a brush on which said powder is contained.

6. A method in accordance with claim 1, wherein said powder is one of a fine metal powder or a fine mineral powder.

7. A method in accordance with claim 1, wherein said powder comprises mica.

8. A method in accordance with claim 1, wherein the powder present on said three-dimensional sculpture exhibits a cracking effect.

9. A method in accordance with claim 8, wherein the cracking effect is dependent on the amount of powder applied to said at least one of said first and second mold surfaces.

10. A method in accordance with claim 1, wherein said first and second mold surfaces are formed from silicone.

11. A method in accordance with claim 1, further comprising the step of creating an electrostatic charge on the mold surface or surfaces to which the powder is applied.

12. A method in accordance with claim 11, wherein said electrostatic charge is created by applying a high-powered jet of air to the mold surface or surfaces to which the powder is applied.

13. A method in accordance with claim 1, wherein said casting material is a plastic material that is clear when cured, such that the only opaque aspect of said three-dimensional sculpture is provided by the powder.

14. A method in accordance with claim 13, wherein said casting material is acrylic.

15. A method in accordance with claim 13, wherein said casting material is clear polyester.

16. A method in accordance with claim 13, wherein said casting material is an epoxy.

17. A method in accordance with claim 1, wherein said powder is applied in a non-uniform intensity to said at least one of said first and second mold surfaces.

18. A method in accordance with claim 1, wherein a first powder is applied to said first mold surface and a second powder different from said first powder is applied to said second mold surface.

19. A method in accordance with claim 18, wherein said first and second powders are different colors.

20. A method in accordance with claim 1, wherein the second mold surface is a negative impression of the first mold surface.

21. A method in accordance with claim 1, wherein the second mold surface is a positive impression of the first mold surface.

22. A method in accordance with claim 1, further comprising the steps of providing a third mold with a third mold casting cavity, supporting said powder-laden three-dimensional sculpture within said third mold casting cavity, pouring another casting material into said third mold casting cavity and around said powder-laden three-dimensional sculpture, curing said another casting material to form a suspended powder-laden three-dimensional sculpture and removing said suspended powder-laden three-dimensional sculpture from said third mold casting cavity.

23. A method in accordance with claim 1, wherein said powder is transferred to a surface of said casting object during curing of said casting material.

24. A method of forming a three-dimensional sculpture comprising the steps of:
a) creating a first mold having a first mold surface that is representative of a first model,
b) creating a second mold having a second mold surface that is representative a second model,
c) applying a first fine powder to said first mold surface,
d) applying a second fine powder to said second mold surface,
e) joining said first and second molds with a casting cavity defined between said first and second mold surfaces,
f) pouring a casting material into said casting cavity and curing said casting material to form a clear casting object, said first and second fine powders being visibly transferred to said casting object during curing of said casting material, and
g) removing said casting object from said casting cavity to form a powder-laden three-dimensional sculpture.

25. A method in accordance with 24, wherein said fine powder is brushed onto at least one of said mold surfaces.

26. A method in accordance with 24, wherein said fine powder is dusted onto at least one of said mold surfaces by tapping a brush on which said fine powder is contained.

27. A method in accordance with 24, wherein said fine powder is rained onto at least one of said mold surfaces by shaking a brush on which said fine powder is contained.

28. A method in accordance with 24, wherein said fine powder is sprayed onto at least one of said mold surfaces.

29. A method in accordance with 24, wherein said fine powder is one of a fine metal powder or a fine mineral powder.

30. A method in accordance with 24, wherein said fine powder comprises mica.

31. A method in accordance with 24, wherein the fine powder present on said three-dimensional sculpture exhibits a cracking effect.

32. A method in accordance with claim 31, wherein the cracking effect is dependent on the amount of fine powder applied to said mold surfaces.

33. A method in accordance with 24, wherein said mold surfaces are formed from silicone.

34. A method in accordance with 24, further comprising the step of creating an electrostatic charge on the mold surfaces prior to applying the fine powders.

35. A method in accordance with claim 34, wherein said electrostatic charge is created by applying a high-powered jet of air to the mold surface or surfaces to which the fine powder is applied.

36. A method in accordance with claim 24, wherein said casting material is acrylic.

37. A method in accordance with claim 24, wherein said casting material is clear polyester.

38. A method in accordance with claim 24, wherein said casting material is epoxy.

39. A method in accordance with 24, wherein said first and second fine powders are different.

40. A method in accordance with claim 39, wherein said first and second fine powders are different colors.

41. A method in accordance with claim 39, wherein said first and second fine powders are different materials.

42. A method in accordance with 24, further comprising the steps of providing a third mold with a third mold casting cavity, supporting said powder-laden three-dimensional sculpture within said third mold casting cavity, pouring another casting material into said third mold casting cavity and around said powder-laden three-dimensional sculpture, curing said another casting material to form a suspended powder-laden three-dimensional sculpture and removing said suspended powder-laden three-dimensional sculpture from said third mold casting cavity.

43. A method in accordance with claim 24, wherein said first and second fine powders are visibly transferred to first and second surfaces of said casting object during curing of said casting material.

44. A method of forming a three-dimensional sculpture comprising the steps of:
a) providing a first mold having a first mold surface and a second mold having a second mold surface, each mold surface having the same contour, one of said mold surfaces being a positive image of said contour and the other of said mold surfaces being a negative image of said contour,
b) applying a first powder to said first mold surface and a second powder to said second mold surface,
c) joining said first and second molds such that a casting cavity is defined between said first and second mold surfaces,
d) pouring a casting material into said casting cavity and curing said casting material to form a casting object having a first and second casting object surface, said first and second powders being transferred from said first and second mold surfaces to said first and second casting object surfaces of said casting object during curing of said casting material, and
e) removing said casting object from said casting cavity to form a powder-laden three-dimensional sculpture.

45. A method in accordance with claim 44, wherein one of said casting object surfaces is visible through the other of said casting object surfaces.

46. A method in accordance with claim 44, wherein said first and second casting surfaces face the same direction.

47. A method in accordance with claim 44, wherein said first and second casting surfaces face different directions.

48. A method in accordance with 44, further comprising the steps of providing a second mold with a second mold casting cavity, supporting said powder-laden three-dimensional sculpture within said second mold casting cavity, pouring another casting material into said second mold casting cavity and around said powder-laden three-dimensional sculpture, curing said another casting material to form a suspended powder-laden three-dimensional sculpture and removing said suspended powder-laden three-dimensional sculpture from said second mold casting cavity.
